(19) United States
(12) Patent Application Publication
(10) Pub. No.: US 2003/0193191 A1
(43) Pub. Date: Oct. 16, 2003

(54) Joiner for pipe ends

(76) Inventor: Adrian Tan, Hong Kong (CN)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/275,716

(22) PCT Filed: May 10, 2001
(86) PCT No.: PCT/AU01/00533

(30) Foreign Application Priority Data
May 11, 2000 (AU) PQ 7438

(51) Int. Cl. F16L 37/00

(52) U.S. Cl. 285/309; 285/374

(57) ABSTRACT

A compression fitting or joiner for joining pipe ends having a plurality of tiltable annuli (17, 18) removably receivable over the pipe ends (6,8) and a fluid sealing housing (11). The fluid sealing housing (11) encloses the annuli (17,18). The annuli (17,18) are restrained from longitudinal movement on one side by means of a tab (5) inserted in an aperture (7) located in the housing (11). When a pull-out force is applied to the pipe end (6 or 8), the housing (11) retrains each annulus (17,18) on one side, causing each annulus to tilt from a position substantially perpendicular to the housing. This tilt reduces the effective lateral cross-sectional area inside each annulus (17,18) resulting in the application of a compressive force to the associated pipe end (6) thereby holding the pipe end (6) within the housing. To subsequently remove the pipe end (6) from the housing (11) a force is applied to remove the tilt from the annuli (17, 18).

### FIELD OF THE INVENTION

This invention relates to a compression fitting which can be used to join two pipe ends together.

### BACKGROUND TO THE INVENTION

In the joining of lengths of pipe, the conventional methods are to fusion heat bond or weld them together, or use a mechanical fitting.

An example of a heat fusion bond is butt-welding. When butt-welding lengths of pipe, the apparatus conventionally used provides support for the two ends of the pipe and incorporates the machining and welding components. In use, the pipes are placed and supported in the apparatus where they are located end to end. The ends of the pipes are then prepared and welded together. Subsequent to the welding of the pipes, they are held in the supporting arrangement by the apparatus until the weld has cooled sufficiently to enable the pipe to be moved from the apparatus without adversely affecting the joint. It is thus not possible to move the welding apparatus until the joint has cooled sufficiently. This has been found to be inefficient.

Also, the quality of welding is dependant on a qualified welder operating within predetermined parameters. The repetitive nature of welding combined with uncomfortable conditions on site frequently result in variation from these parameters causing the welded joint to fail.

The use of mechanical fittings is another conventional method of joining pipes together. For example, to join polyethylene pipes together requires adaptor fittings to be welded to the end of the pipe to prepare them for the subsequent application of the mechanical fitting. This increases the cost of the joint, as it requires two butt welds, two adaptor fittings and one mechanical fitting. This mechanical fitting is commonly manufactured from metal and adapts to the changing shape of the plastic pipe under stress.

All conventional mechanical fittings require the application of bolts or nuts to apply the compression onto the pipe. This has been found to be inefficient as the bolts are frequency damaged during installation or operation and nuts may not be tightened sufficiently.

A peculiar problem in relation to widely-used polyethylene pipes is that they are known to reduce in outside diameter when under pressure for an extended period of time, when pressure is removed from the pipeline, and when the temperature of the pipes reduce significantly below the installation temperature.

Another type of conventional fitting is one that does not require adaptor fittings and butt welds and prevents the pipe from pulling out by the application of compression on the pipe. When the fitting is produced from metal however, this type of fitting has been found in practice to produce a joint that cannot maintain the compression when a polyethylene pipe reduces in outside diameter.

### SUMMARY OF THE INVENTION

The present invention has been developed to provide a simple yet effective compression fitting for joining pipe ends which is self-locking and self-adjusting to maintain compressive stresses in service without the limitations of welding or mechanical fittings.

Throughout this specification the term “comprising” is used inclusively, in the sense that there may be other features and/or steps included in the invention not expressly defined or comprehended in the features or steps subsequently defined or described. What such other features and/or steps may include will be apparent from the specification read as a whole.

According to one aspect of the invention there is provided a compression fitting for joining a first pipe end to a second pipe end, the fitting comprising:

a plurality of tiltable annuli removably receivable over said second pipe end; and

a fluid sealing housing provided in connection with said first pipe end for enclosing said annuli and restraining said annuli from longitudinal movement on one side, said housing being shaped to receive said second pipe end within said annuli;

whereby, in use, upon application of a pull-out force to the first and/or second pipe end, said housing restrains each annulus on one side of the housing thereby causing each annulus to tilt from a position substantially perpendicular to the housing, and wherein said tilt reduces the effective lateral cross-sectional area inside each annulus resulting in the application of a compressive force to the second pipe end for holding said second pipe end within the housing.

Preferably each annulus has a mechanical restraint provided in connection therewith at one point of its circumference. Preferably said mechanical restraint comprises a tab that protrudes from an outer circumference of the annulus. Preferably said housing is provided with an aperture for receiving said tab and restraining each respective annulus from longitudinal movement. Preferably said aperture is of sufficient size to receive said tab and allow said tab longitudinal movement as each annulus tilts without pull-out of the tab from the aperture.

Preferably, the housing further includes a boss to assist in correct positioning of said pipe end during assembly.

Preferably, the housing farther includes at least one fluid seal provided between the housing and said second pipe end. More preferably said fluid seal comprises one or more ‘O’ rings.

Preferably said annuli are sufficiently rigid to resist permanent deformation upon application of the pullout force. Optionally, the annuli may be provided with a stiffness enhancing member. Typically said stiffness enhancing member is a web connected to the curved surface of the annuli. Preferably said web is one of a plurality of webs connected to the curved surface of the annuli.

Preferably, the pipe ends are made from polyethylene. More preferably the pipe ends are made from high molecular weight polyethylene.

Preferably, the annuli are made from steel. More preferably, the steel annuli are polymer coated.

Preferably, the housing is made from polyethylene.

Optionally the compression fitting further comprises a release mechanism for restoring the annuli to the position substantially perpendicular to the housing such that the housing is readily removable from said pipe end. Preferably said release mechanism comprises a plurality of elongate release members, each release member being mechanically coupled to a respective annulus, said member having a length which permits the transmission of a force to the annulus, whereby, in use, upon application of said force to the annulus, the tilt of each annulus returns to a position substantially perpendicular to the pipe end.

According to another aspect of the present invention there is provided a joiner for joining at the gap between first and second pipe ends, the joiner comprising:

a fluid sealing housing removably receivable over said first and second pipe ends and adapted to bridge the gap between said pipe ends; and

a plurality of tiltable annuli removably receivable over said pipe ends and being enclosed within and restrained on one side from longitudinal movement relative to said fluid sealing housing;

whereby, in use, upon application of a pull-out force to the first and/or second pipe ends, said housing restrains each annulus on one side of the housing thereby causing each annulus to tilt from a position substantially perpendicular to the housing, and wherein said tilt reduces the effective lateral cross-sectional area inside each annulus resulting in the application of a compressive force to the first and/or second pipe ends for joining said first pipe to said second pipe end within the housing.

Preferably each annulus has a mechanical restraint provided in connection therewith at one point of its circumference.

Preferably said mechanical restraint comprises a tab that protrudes from an outer circumference of the annulus.

Preferably said housing is provided with an aperture for receiving said tab and restraining each respective annulus from longitudinal movement.

Preferably said aperture is of sufficient size to receive said tab and allow each tab sufficient lateral movement as each annulus tilts without pull-out of the tab from the aperture.

Preferably, the housing further includes a boss to assist in correct positioning of said pipe end during assembly.

Preferably, the housing further includes at least one fluid seal provided between the housing and said second pipe end. More preferably said fluid seal comprises one or more ‘O’ rings.

Preferably said annuli are sufficiently rigid to resist permanent deformation upon application of the pullout force. Optionally, the annuli may be provided with a stiffness enhancing member. Typically said stiffness enhancing member is a web connected to the curved surface of the annuli. Preferably said web is one of a plurality of webs connected to the curved surface of the annuli.

Preferably, the pipe ends are made from polyethylene. More preferably the pipe ends are made from high molecular weight polyethylene.

Preferably, the annuli are made from steel. More preferably, the steel annuli are polymer coated.

Preferably, the housing is made from polyethylene.

Optionally the joiner further comprises a release mechanism for restoring the annuli to the position substantially perpendicular to the housing such that the housing is readily removable from said pipe end. Preferably said release mechanism comprises a plurality of elongate release members, each release member being mechanically coupled to a respective annulus, said member having a length which permits the transmission of a force to the annulus, whereby, in use, upon application of said force to the annulus, the tilt of each annulus returns to a position substantially perpendicular to the housing.

### BRIEF DESCRIPTION OF THE DRAWINGS

In order to facilitate a more detailed understanding of the nature of the invention a preferred embodiment of the compression fitting for joining pipe ends will now be described in detail, by way of example, only, with reference to the accompanying drawings, in which:

FIG. 1 is a general isometric external view of one embodiment of the compression fitting of the present invention.

FIG. 2 is a partly sectional isometric view of one embodiment of the compression fitting showing the internal arrangement of components upon assembly and prior to the application of a pull-out force on the pipe ends.

FIG. 3 is a partly sectional isometric view illustrating the effect of applying a pull-out force to the pipe ends.

FIG. 4 shows a side view of the compression fitting with the side of the housing removed for clarity showing the position of the annuli upon assembly and after pull-out of the pipe ends.

FIG. 5 is a partly sectional isometric view of the second embodiment of the present invention showing the positioning of the plugs.

### DETAILED DESCRIPTION OF PREFERRED EMBODIMENTS

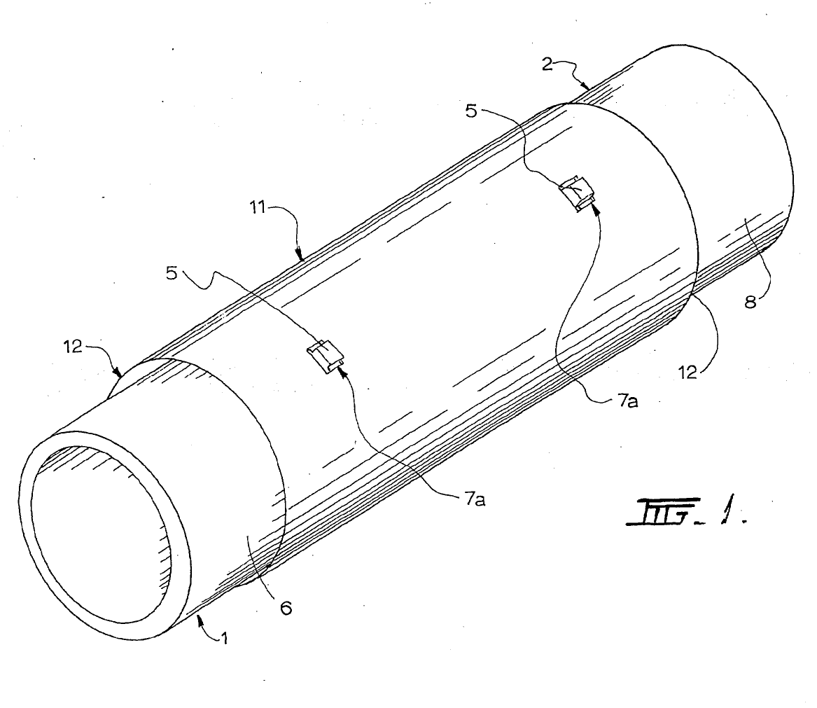

In the first embodiment of this invention, two pipes 1 and 2 having pipe ends 6 and 8 respectively are to be joined together. For clarity, the discussion to follow and FIGS. 1-3 describe the operation of the compression fitting or joiner in relation to pipe end 6 only. The mode of operation is equally applicable to pipe end 8.

In FIGS. 1-3 only the ends 6 and 8 of the pipe are shown, it being understood that the pipes 1 and 2 extend away from the fitting in each direction.

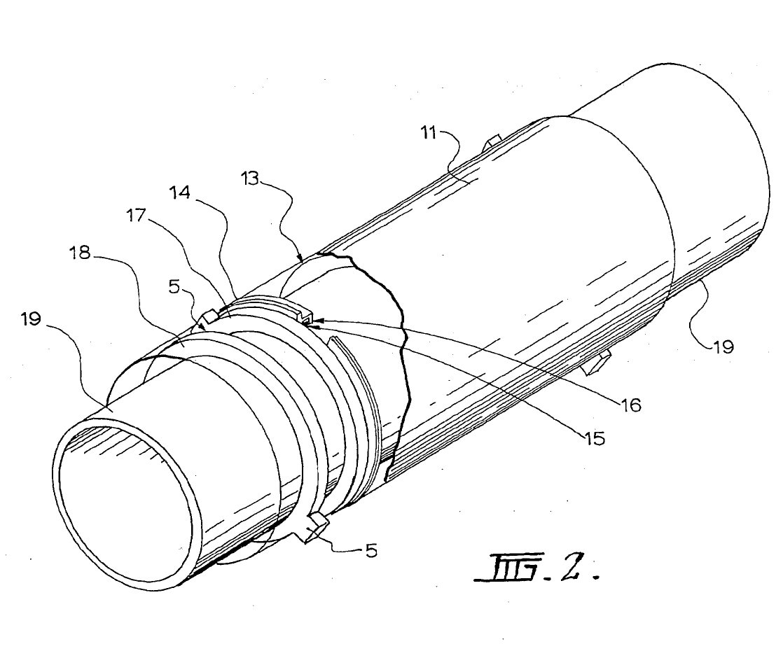

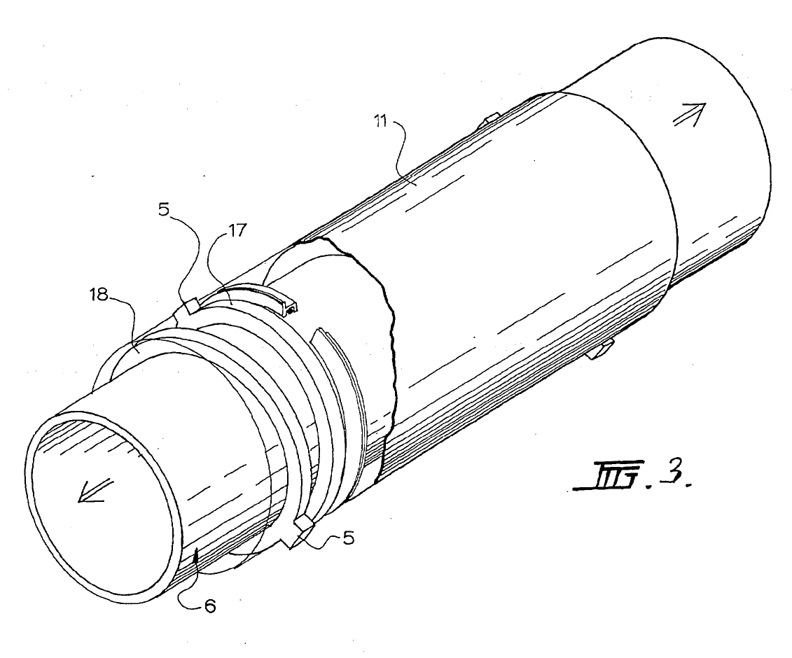

FIGS. 2, 3 and 4 show the internal detail of the position of the annuli relative to pipe end 6 and the housing 11, it being understood that a similar arrangement of parts exists at pipe end 8, not shown in FIGS. 2 and 3.

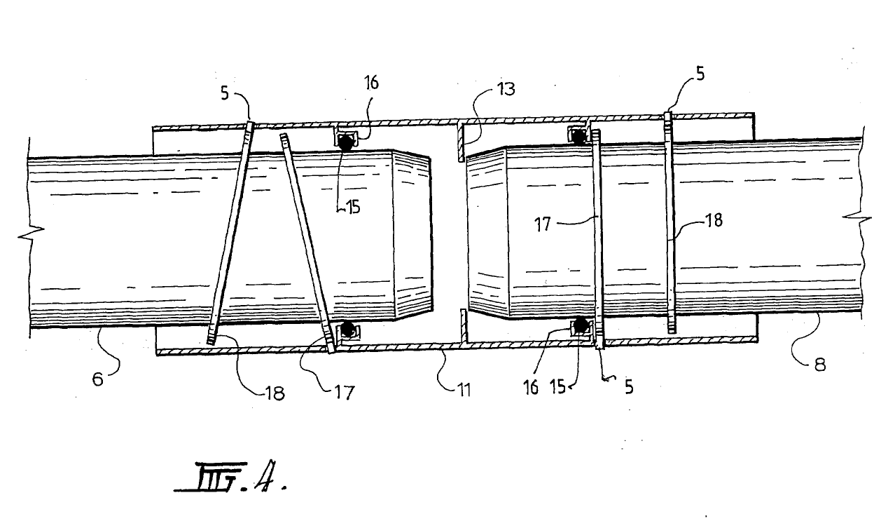

When pipe end 6 is inserted into housing 11 it passes through annuli 17 and 18. When the pipe end is fully inserted and the joint is subjected to pullout forces, usually by pressurisation of the pipeline, the pullout force causes the pipe end 6 to move away from the housing 11 thereby causing annuli 17 and 18 to tilt as seen best in FIG. 4. Note that the same actions would take place at pipe end 8. This tilting motion of the annuli reduces the effective lateral cross-sectional area inside each annulus resulting in the application of a compressive force to the pipe end, causing the annuli 17 and 18 to grip the outside of the pipe end thereby preventing the further pullout motion of the pipe end away from the housing.

Each annulus 17 and 18 is mechanically restrained from lateral movement by means of a tab S provided as part of each annulus. Tab 5 is locatable within diametrically opposed apertures 7a (shown in FIG. 2) and 7b (not visible) in housing 11. Prior to insertion of pipe end 6, annuli 17 and 18 are inserted into housing 11 and located by way of inserting tab 5 of annulus 17 into aperture 7a and inserting tab 5 of annulus 18 into aperture 7b. Before and during insertion of pipe end 6, annuli 17 and 18 maintain a position substantially perpendicular to the direction of motion of the pipe end.

Each tab 5 must be of sufficient cross section to prevent visible deformation at the apertures 7 of the housing 11 under pressure. When the annuli are assembled within the housing, the tabs 5 protrude through apertures 7 as shown best in FIG. 1. The dimensions of the apertures are defined by the permission offered by the housing 11 of unrestrained tilt by the annuli resulting from the pullout of the pipe ends. As the pipe end pulls out, the annuli travel with the pipe until the tabs 5 of each annulus connects with the edge of the respective aperture 7.

Each pipe end is preferably restrained from pullout by a pair of annuli, each annuli having a tab located 180 degrees from the other. The orientation of the tabs of the annuli is defined by the requirement of the pipe end to remain parallel to the housing. If desired, additional security against pullout of the pipe end and increased distribution of the stresses through the housing may be employed by including additional annuli with tabs located in apertures uniformly distributed around the circumference of the housing.

Contained within housing 11 and midway along its longitudinal axis is boss 13 connected to the inside surface of the housing. The outside diameter of boss 13 is defined by the inside diameter of the housing 11. The inside diameter of boss 13 is defined by the outside diameter of pipe end 6. Boss 13 will stop the motion of the pipe end during insertion.

Also contained within the housing are two identical rings 14 of mirrored orientation about the longitudinal axis of the housing 11, and rubber seal ring 15. The outside diameter of the rings 14 will be defined by the outside diameter of the housing 11 and the inside diameter of the rings 14 will be defined by the dimension required to permit free passage of the pipe ends and prevent the passage of the rubber seal ring 15 under pressure.

The rings 14 are connected to the inside surface of the housing in a manner defined by a requirement to prevent egress of the contained fluid and prevent movement of the rings 14 under pressure. Attached to the rings 14 is a seal retaining ring 16, which in conjunction with ring 14 locates and contains rubber seal ring 15. The inside diameter of the retaining ring 16 is defined by the dimensions of the seal ring 15.

Annuli 17, 18 have an internal diameter which will enable them to be closely engaged with pipe end 6. The outside diameter of the annuli will be defined by their rigidity which is pursuant to prevention of pullout of pipe end 6. The inside diameter of the housing will be defined by the permission of unrestrained tilt of the annuli. If desired the rigidity of the annuli may be improved by way of webs connected to the curved surface of the annuli, thereby enabling the reduction of the effective cross-sectional area of annuli 17 and 18 and therefore also the inside diameter of the housing 11.

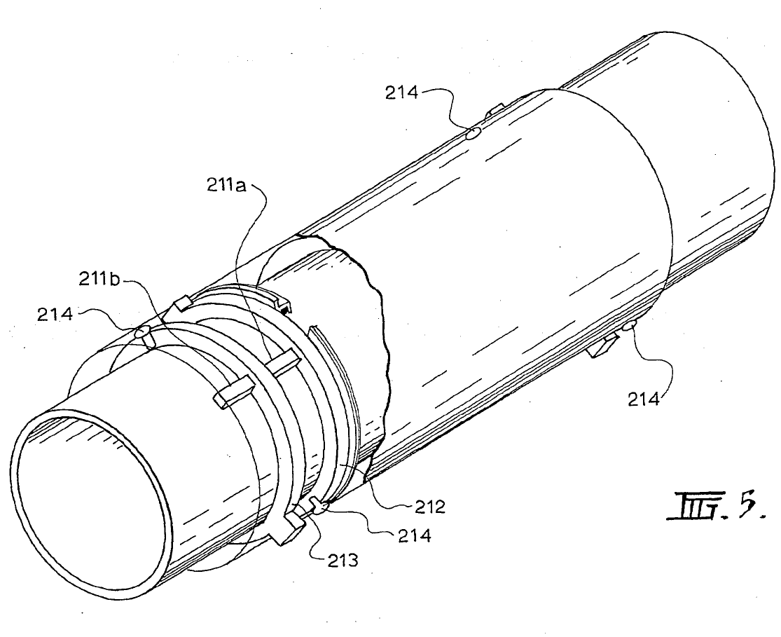

A second embodiment of the invention is shown in FIG. 5. Annuli 212 and 213 are contained within housing 11 as described in the first embodiment. In this embodiment, there are also included a release mechanism comprising members 211a and 211b. The length of first member 211a is defined by the distance between the two adjacent annuli 212 and 213. The length of the second member 211b is defined by the distance from the end of annulus 213 facing away from the centre of the housing and the end of the housing. The function of members 211 is to permit the removal of housing 11 from the pipe end 6 by way of application of force on member 211b closest to the end of the housing 11, said force restoring the tilt of the annulus 213 towards perpendicular to the longitudinal axis of the pipe end.

During such tilt reduction, annulus 213 will contact member 211a, causing annulus 212 also to reduce tilt in the same direction. Such force is applied until both annuli 212 and 213 approximate a position perpendicular to the housing. Continued application of the force will cause the extraction of the housing from the pipe end. The same process may be used to extract the other pipe end from the housing.

An alternative to the members 211 of the second embodiment is to place pins 214 through the body of the housing in front of the annuli 212 and 213 such that the pins are in the position perpendicular to the pipe. The pins 214 prevent the annuli 212 and 213 from tilting when the pipe ends are withdrawn thereby permitting easy pipe removal.

The provision of a release mechanism is optional. The annuli may be returned to the position substantially perpendicular to the housing by means of the application of sufficient longitudinal force to the pipe ends in the direction of the housing.

It will be apparent from the foregoing description that the preferred embodiments of the compression fitting and joiner have a number of significant advantages, including but not limited to the following:

(a) simpler yet as effective as any other currently available means of joining pipes

(b) self-locking and self-adjusting

(c) compressive stresses in service are maintained without requiring readjustment as for mechanical fittings;

(d) insertion of the pipe ends and establishment of compression is achieved in a one step operation;

(e) removal of the fitting from the pipe end is also achievable in a one step operation;

(f) removal and replacement of the fitting are able to be done without requiring preparation of the pipe ends before re-use.

Numerous variations and modifications will suggest themselves to persons skilled in the pipe joining arts, in addition to those already described, without departing from the basic inventive concepts. For example, while the preferred embodiments described the joining of polyethylene pipes, the apparatus as claimed may be used to join pipes of other materials. Furthermore the invention need not have application to the mounting and joining of a pair of elongate members being mounted in an end to end relationship but may have application where support is required for two or more intersecting elements or components during or immediately subsequent to the joining process. All such variations and modifications are to be considered within the scope of the present invention, the nature of which is to be determined from the foregoing description and the appended claims.

The claims defining the invention are as follows:

1. A compression fitting for joining a first pipe end to a second pipe end, the fitting comprising:
a plurality of tiltable annuli removably receivable over said second pipe end; and
a fluid sealing housing provided in connection with said first pipe end for enclosing said annuli and restraining said annuli from longitudinal movement on one side, said housing being shaped to receive said second pipe end within said annuli, said housing comprising sealing means relatively juxtaposed to said annuli so that as said annuli tilt said sealing means remains spaced apart from said annuli;
whereby, in use, upon application of a pull-out force to first and/or second pipe end, said housing restrains each annulus on one side of the housing thereby causing each annulus to tilt from a position substantially perpendicular to the housing, and wherein said tilt reduces the effective lateral cross-sectional area inside each annulus resulting in the application of a compressive force to the second pipe end for holding said second pipe end within the housing.

2. A compression fitting according to claim 1 wherein each annulus fiber comprises a stiffness enhancing member.

3. A compressing fitting according to claim 2 wherein said stiffness enhancing member is a web connected to a curved surface of said annulus.

4. A compression fitting according to claim 3 wherein said web is one of a plurality of webs connected to the curved surface of the annulus.

5. A compressing fitting according to claim 1 wherein at least one of said annuli is releasably tiltable in a first direction and at least one of another of said annuli is releasably tiltable in an opposing direction.

6. A compression fitting according to claim 5 wherein each annulus has a mechanical restraint provided in connection therewith at one point of its circumference.

7. A compressing fitting according to claim 6 wherein said mechanical restraint comprises a tab that protrudes from an outer circumference of the annulus.

8. A compressing fitting according to claim 7 wherein said housing is provided with an aperture for receiving said tab and restraining each respective annulus from longitudinal movement.

9. A compressing fitting according to claim 8 wherein said aperture is of sufficient size to receive said tab and allow said tab longitudinal movement as each annulus tilts without pull-out of the tab from the aperture.

10. A compression fitting according to claim 1 wherein the housing further includes a boss to assist in correct positioning of said pipe end during assembly.

11. A compressing fitting according to claim 1 wherein the housing is made from polyethylene.

12. A compressing fitting according to claim 1 further comprising a release mechanism for restoring the annuli to the position substantially perpendicular to the housing such that the housing is readily removable from said pipe end.

13. A compression fitting according to claim 12 wherein said release mechanism comprises a plurality of elongate release members, each release member being mechanically coupled to a respective annulus, said member having a length which permits the transmission of a force to the annulus, whereby, in use, upon application of said force to the annulus, the tilt of each annulus returns to a position substantially perpendicular to the pipe end.

14. A joiner for joining first and second pipe ends defining a gap therebetween, including a compression fitting in accordance with claim 1.
